(19) United States
(12) Patent Application Publication
(10) Pub. No.: US 2005/0037238 A1
(43) Pub. Date: Feb. 17, 2005

(54) Perpendicular magnetic recording medium and method for production thereof

(75) Inventors: Yasushi Sakai, Kawasaki-shi (JP); Akihiro Ohtsuki, Kawasaki-shi (JP); Keiji Ohkubo, Kawasaki-shi (JP); Kazuo Enomoto, Kawasaki-shi (JP); Sadayuki Watanabe, Kawasaki-shi (JP); Takahiko Tamaki, Tokyo (JP); Kiyoshi Kuga, Tokyo (JP); Eiichi Miyashita, Tokyo (JP); Ryo Taguchi, Tokyo (JP)

Correspondence Address: VENABLE, BAETJER, HOWARD AND CIVILETTI, LLP, P.O. BOX 34385, WASHINGTON, DC, 20043-9998, US

(73) Assignees: Fuji Electric Co., Ltd., Kanagawa (JP); Nippon Hoso Kyokai, Tokyo (JP)

(21) Appl. No.: 10/934,555

(22) Filed: Sep. 7, 2004

Related U.S. Application Data
(62) Division of application No. 10/223,705, filed on Aug. 20, 2002, now abandoned.

(30) Foreign Application Priority Data
Aug. 23, 2001 (JP) 2001-253128

(51) Int. Cl. B05D 5/12; B05D 1/36; B05D 3/08; G11B 5/64

(52) U.S. Cl. 428/694 TS; 428/694 TP; 427/127; 427/131; 427/191; 427/203; 427/205

(57) ABSTRACT

The present invention provides a method for easily obtaining a perpendicular magnetic recording medium having the desired magnetic properties by sputtering, and a magnetic recording medium obtained by this method. The perpendicular magnetic recording medium of the present invention is a perpendicular magnetic recording medium comprising at least a soft magnetic underlayer, an underlayer, a magnetic recording layer, a protective layer, and a liquid lubricant layer sequentially laminated on a nonmagnetic substrate, wherein the magnetic recording layer is a rare earth-transition metal alloy amorphous film formed by sputtering, and the formation of the magnetic recording layer by sputtering is performed using a film-forming gas incorporating 2% or more, but 60% or less of an H₂ gas. The present invention also discloses a method for producing the perpendicular magnetic recording medium.

This application is based on Patent Application No. 2001-253128 filed Aug. 23, 2001 in Japan, the content of which is incorporated hereinto by reference.

### BACKGROUND OF THE INVENTION

1. Field of the Invention

This invention relates to a perpendicular magnetic recording medium to be mounted on various magnetic recording devices, and a method for producing it.

2. Description of the Related Art

With the increase in the capacity of magnetic disc recorders, a demand is growing for the high recording density of magnetic recording media. Of conventional magnetic recording systems, a longitudinal magnetic recording system is predominant. Recently, a perpendicular magnetic recording system has attracted attention as a technique for achieving the high recording density of magnetic recording.

A perpendicular magnetic recording medium includes, as constituent elements, a magnetic recording layer of a hard magnetic material, and a underlayer made of a soft magnetic material and playing a role in concentrating a magnetic flux generated by a magnetic head which is used for recording into the recording layer. As a material for the magnetic recording layer of the perpendicular magnetic recording medium, a CoCr-based alloy crystalline film is mainly used at present. With this film, a coercive force (Hc) of the order of 4,000 Oe is a maximum value, and a further increase in the coercive force is necessary for achieving a higher density. Fulfillment of this requirement noses technical difficulties.

As a material for magneto-optical recording, a rare earth-transition metal alloy amorphous film is used. Since this film has a high perpendicular magnetic anisotropy constant (Ku), it is also very promising as a material for a magnetic recording layer of a perpendicular magnetic recording medium. However, a composition close to the compensation point is used in magneto-optical recording. Hc in this composition range is considerably greater than Hc required of a material for perpendicular magnetic recording.

As described above, a rare earth-transition metal alloy amorphous film is expected to be used as a material for a perpendicular magnetic recording medium. To meet this expectation, it is necessary to change its magnetic properties to desired properties. To obtain the desired properties, it is conceivable to change the proportions of the rare earth element and the transition metal in the composition. Once the composition is fixed, however, the values of Ku and saturation magnetic flux density (Ms) are uniquely determined. This makes it difficult to design the magnetic properties in a balanced manner by changing the composition. Moreover, when the intended magnetic properties are to be obtained by adjusting the proportions in the composition, it is difficult to readjust the magnetic properties to the intended value, if the magnetic properties vary during mass production, or if a variation occurs in the composition of the target for sputtering with the progress of production.

### SUMMARY OF THE INVENTION

The present inventors developed a method for producing a perpendicular magnetic recording medium having the desired magnetic properties by using a rare earth-transition metal alloy amorphous film as a magnetic recording layer, and using sputtering for the formation of this magnetic recording layer, without the need to change the proportions of a rare earth element and a transition metal in the composition of a target of sputtering. The inventors found that the desired magnetic recording medium can be obtained by this method.

The present invention provides a magnetic recording medium comprising a rare earth-transition metal alloy amorphous film as a magnetic recording layer, wherein the magnetic recording medium is produced by a method that can easily obtains a perpendicular magnetic recording medium having the desired magnetic properties. The present invention further provides a method for easily obtaining a perpendicular magnetic recording medium having the desired magnetic properties, without changing the proportions of a rare earth element and a transition metal of a target for sputtering.

More specifically, the present invention has the following aspects:

A first aspect of the invention is a perpendicular magnetic recording medium comprising at least a soft magnetic underlayer, an underlayer, a magnetic recording layer, a protective layer and a liquid lubricant layer sequentially laminated on a nonmagnetic substrate, wherein the magnetic recording layer is a rare earth-transition metal alloy amorphous film formed by sputtering, and wherein the formation of the magnetic recording layer by sputtering is performed using a film-forming gas incorporating 2% or more, but 60% or less of an H₂ gas.

A second aspect of the invention is a method for producing a perpendicular magnetic recording medium, comprising the steps of sequentially laminating at least a soft magnetic underlayer, an underlayer, a magnetic recording layer, a protective layer and a liquid lubricant layer on a nonmagnetic substrate, wherein the magnetic recording layer is a rare earth-transition metal alloy amorphous film formed by sputtering, and wherein the formation of the magnetic recording layer by sputtering is performed using a film-forming gas incorporating 2% or more, but 60% or less of an H₂ gas.

More specifically, the method for producing the perpendicular magnetic recording medium of the invention is as follows:

A method for producing a perpendicular magnetic recording medium, comprising the steps of:
(1) forming a soft magnetic underlayer on a nonmagnetic substrate,
(2) forming an underlayer on the soft magnetic underlayer,
(3) forming a magnetic recording layer on the underlayer,
(4) forming a protective layer on the magnetic recording layer, and
(5) forming a liquid lubricant layer on the protective layer,
wherein the magnetic recording layer is a rare earth-transition metal alloy amorphous film,
the rare earth-transition metal alloy amorphous film is formed by sputtering, and
the formation of the rare earth-transition metal alloy amorphous film by sputtering is performed using a film-forming gas incorporating 2% or more, but 60% or less of an H₂ gas.

According to the present invention, a perpendicular magnetic recording medium having the desired magnetic properties can be obtained by using a rare earth-transition metal alloy amorphous film as a magnetic recording layer of the perpendicular magnetic recording medium, and by adding an H₂ gas to a film-forming gas and adjusting the amount of the H₂ gas within the range of 2% to 60% inclusive when forming the film by sputtering.

The method for producing the perpendicular magnetic recording medium of the present invention can be performed by a simple procedure using an existing manufacturing device. Thus, this method is suitable for mass production of a high-capacity magnetic recording medium.

Furthermore, the magnetic recording medium produced by the method of the present invention has the desired magnetic properties, and proves suitable as a high-capacity magnetic recording medium.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a schematic partial sectional view of a perpendicular magnetic recording medium according to the present invention;

FIG. 2 is a graph showing the dependence of the concentrations of Tb and Co in the perpendicular magnetic recording medium according to the present invention on the amount of H₂ gas added;

FIG. 3 is a graph showing the dependence of the coercive force (Hc) of the perpendicular magnetic recording medium according to the present invention on the amount of H₂ gas added; and

FIG. 4 is a graph showing the dependence of the perpendicular magnetic anisotropy constant (Ku) of the perpendicular magnetic recording medium according to the present invention on the amount of H₂ gas added.

### DETAILED DESCRIPTION OF PREFERRED EMBODIMENTS

The present invention will be described in further detail below.

The first aspect of the present invention relates to a perpendicular magnetic recording medium.

The perpendicular magnetic recording medium of the present invention is characterized in that a rare earth-transition metal alloy amorphous film is used as a magnetic recording layer, this film is formed by sputtering, and 2% to 60% inclusive of an H₂ gas is added to a film-forming gas used in film formation. The present invention is based on the finding that when a rare earth-transition metal alloy amorphous material is to be formed into a film by sputtering, an H₂-containing gas is used as a gas for film formation, and the proportion of this H₂ gas added is varied, whereby the magnetic properties can be controlled to any value.

Hereinafter, the first aspect of the invention will be described with reference to the accompanying drawings, but the following description shows an embodiment of the invention, and the present invention is not limited thereto.

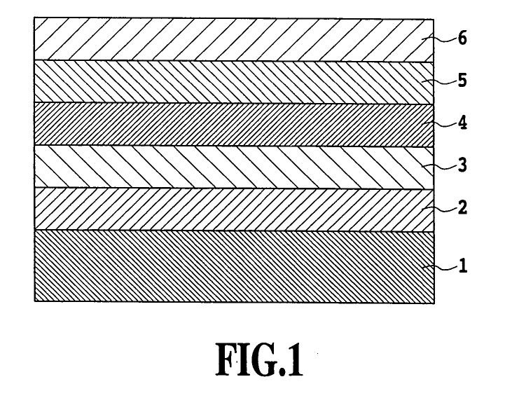

FIG. 1 is a schematic partial sectional view of a perpendicular magnetic recording medium according to the present invention. As shown in FIG. 1, the perpendicular magnetic recording medium according to the present invention has a structure in which at least a soft magnetic underlayer 2, an underlayer 3, a magnetic recording layer 4, a protective layer 5, and a liquid lubricant layer 6 are sequentially laminated on a nonmagnetic substrate 1.

In the present invention, the nonmagnetic substrate 1 is formed from a material hitherto used for a magnetic recording medium. For example, a nickel-phosphorus (NiP) plated aluminum (Al) alloy, chemical strengthened glass, or crystallized glass can be used as a material for the substrate 1.

The soft magnetic underlayer 2 may be an NiFe alloy or a Sendust (FiSiAl) alloy, but the use of an amorphous Co alloy is preferred. The amorphous Co alloy can be obtained by adding Zr, Nb, Ta, Hf, Ti and/or W to Co. Examples of the amorphous Co alloy preferably used in the present invention are CoZrNb, CoZrHf, and CoHfTa, of which CoZrNb is particularly preferred. In the case of CoZrNb, its alloy preferably contains 5 to 20 atomic % of Zr and 3 to 15 atomic % of Nb. The film thickness of the soft magnetic underlayer 2 has an optimal value varying with the structure and characteristics of a magnetic head used in recording. Preferably, the optimal value is 10 nm or more, but 300 nm or less.

In the present invention, a layer for exercising magnetic domain control may be provided between the nonmagnetic substrate 1 and the soft magnetic underlayer 2. An example of this layer is an antiferromagnetic layer comprising an Mn alloy, or a hard magnetic layer having magnetization oriented in the radial direction of the nonmagnetic substrate 1. If this film is provided, its thickness is preferably of the order of 5 to 300 nm.

The underlayer 3 is used to control the properties of the magnetic recording layer 4. As the underlayer 3, Ti, TiCr or the like is used, for example, for the purpose of preventing oxidation of the rare earth element. The use of a CoCr-based alloy crystalline film for the purpose of fixing signals written into the magnetic recording layer is also very effective in producing a perpendicular magnetic recording medium of a high recording density. The film thickness of the underlayer 3 is preferably 5 to 30 nm.

In the present invention, the substrate 1 is prepared by the customary method. A conventional method, such as vapor deposition, sputtering, or CVD, can be used for the film formation of the soft magnetic underlayer 2 and the underlayer 3.

The magnetic recording layer 4 comprises a rare earth-transition metal alloy amorphous film. As a material for use in the rare earth-transition metal alloy amorphous film, an alloy-based material such as TbCo or TbFeCo is used.

The present invention is characterized by a film formation process for this magnetic recording layer 4. In the present invention, the magnetic recording layer 4 is formed as a film by sputtering. As will be described in detail in the Example to be offered later, 2% to 60% inclusive of an H₂ gas is added to a film-forming gas. By adding the H₂ gas and controlling the proportion of the H₂ gas added, the magnetic properties can be controlled to an arbitrary value, and the desired magnetic properties can be imparted to the magnetic recording medium of the present invention. The film thickness of the magnetic recording layer 4 is 5 to 100 nm, preferably 10 to 50 nm.

A conventional protective layer can be used as the protective layer 5. For example, a protective layer consisting essentially of carbon can be employed.

A conventional material for a liquid lubricant layer can be used in the liquid lubricant layer 6. For example, lubricants of perfluoropolyethers can be employed.

The conditions for the protective layer 5 and the liquid lubricant layer 6, such as film thickness can use the conditions for the ordinary magnetic recording medium without changed them.

Next, the second aspect of the invention will be described.

The second aspect of the invention relates to a method for producing a perpendicular magnetic recording medium. This method for producing a perpendicular magnetic recording medium comprises the steps of sequentially laminating at least a soft magnetic underlayer, an underlayer, a magnetic recording layer, a protective layer, and a liquid lubricant layer on a nonmagnetic substrate, wherein the magnetic recording layer is a rare earth-transition metal alloy amorphous film formed by sputtering, and the formation of the magnetic recording layer by sputtering is performed using a film-forming gas containing 2% or more, but 60% or less of an H₂ gas.

In the present invention, the formation of the soft magnetic underlayer, the underlayer, and the protective layer can be performed by use of a technique such as vapor deposition, sputtering or CVD. The magnetic recording layer can be formed by sputtering. The above-mentioned respective layers can be formed separately, but is preferably formed in a single step by use of sputtering.

The liquid lubricant layer may be applied by dip coating, spin coating or the like onto the magnetic recording medium obtained by the methods described above.

According to the present invention, an H₂ gas is added in an amount of 2% to 60% inclusive to the film-forming gas for use in sputtering in the sputtering step for formation of the magnetic recording layer. By adding the H₂ gas and controlling the amount of the H₂ gas added, the magnetic properties of the magnetic recording medium can be controlled arbitrarily. If the amount of the H₂ gas added is lower than 2%, the perpendicular magnetic anisotropy constant (Ku) will be too great. If the amount of the H₂ gas added exceeds 60%, on the other hand, the magnetic recording layer 4 will become a longitudinally magnetized film. Therefore, the amount of the H₂ gas added is preferably 2% or more, but 60% or less.

In the perpendicular magnetic recording medium of the present invention, the layer for exercising magnetic domain control may be provided between the nonmagnetic substrate 1 and the soft magnetic underlayer 2, as stated earlier. Thus, the step of forming this layer may be further provided. As this layer, it is possible to provide, for example, an antiferromagnetic layer comprising an Mn alloy, or a hard magnetic layer having magnetization oriented in the radial direction of the nonmagnetic substrate 1, as explained in connection with the first aspect of the invention. For the formation of this layer, a technique, such as vapor deposition, sputtering or CVD, can be employed.

If described more specifically, the method for producing the perpendicular magnetic recording medium of the present invention comprises the following steps:
(1) the step of forming a soft magnetic underlayer on a nonmagnetic substrate,
(2) the step of forming an underlayer on the soft magnetic underlayer,
(3) the step of forming a magnetic recording layer on the underlayer,
(4) the step of forming a protective layer on the magnetic recording layer, and
(5) the step of forming a liquid lubricant layer on the protective layer.

Further, the present invention is characterized in that the magnetic recording layer is a rare earth-transition metal alloy amorphous film, the rare earth-transition metal alloy amorphous film is formed by sputtering, and the formation of the rare earth-transition metal alloy amorphous film by sputtering is performed using a film-forming gas incorporating 2% or more, but 60% or less of an H₂ gas.

Steps (1) to (4)

In the method for production according to the present invention, a substrate for a magnetic recording medium (i.e., a nonmagnetic substrate) is provided. Then, the above-described steps (1) to (4) are performed sequentially. In the production method of the present invention, the nonmagnetic substrate, soft magnetic underlayer, underlayer, magnetic recording layer, and protective layer may be those described in connection with the first aspect of the invent on. For example, a chemical strengthened glass substrate for a magnetic recording medium can be used as the nonmagnetic substrate 1. In this case, the glass substrate is preferably produced by a conventional technique, and further subjected to predetermined surface treatments, such as smoothing and cleaning. The respective layers are sequentially laminated on this substrate. Lamination can be performed with the use of sputtering. For example, the steps (1) to (4) can be performed by using DC magnetron sputtering at a gas pressure of 5 mTorr. In this case, it is not necessary to take out the substrate after formation of each layer each time, and film formation can be carried out in a single step. It goes without saying that the respective steps can be performed separately. When the respective steps are to be performed separately, the steps (1), (2) and (4) can employ techniques such as vapor deposition, sputtering and CVD.

According to the present invention, 2% to 60% inclusive of an H₂ gas is added to the film-forming gas during film formation of the magnetic recording layer in the above-mentioned step (3). By adding the H₂ gas and controlling the amount of the H₂ gas added, the magnetic properties of the magnetic recording medium can be controlled arbitrarily. If the amount of the H₂ gas added is lower than 2%, the perpendicular magnetic anisotropy constant (Ku) will be too great. If the amount of the H₂ gas added exceeds 60%, on the other hand, the magnetic recording layer 4 will become a longitudinally magnetized film. Therefore, the amount of the H₂ gas added is preferably 2% or more, but 60% or less.

In the present invention, moreover, the step of forming a layer for exercising magnetic domain control may be provided between the steps (1) and (2). As this layer, it is possible to provide, for example, an antiferromagnetic layer comprising an Mn alloy, or a hard magnetic layer having magnetization oriented in the radial direction of the nonmagnetic substrate 1, as explained in connection with the first aspect of the invention. For the formation of this layer, a technique, such as vapor deposition, sputtering or CVD, can be employed.

Step (5)

Formation of the liquid lubricant layer can be performed using a conventional method. For example, a liquid lubricant comprising perfluoropolyether may be applied by dip coating, spin coating or the like onto the magnetic recording medium obtained by the steps (1) to (4) described above.

According to the above-described method for producing the perpendicular magnetic recording medium of the present invention, when the rare earth-transition metal alloy amorphous film is to be formed, an H₂ gas is added to the film-forming gas, and the proportion of the gas added is adjusted. By so doing, it becomes possible to adjust the composition of the resulting rare earth-transition metal alloy amorphous film, without changing the composition of the target of sputtering.

Hereinbelow, the present invention will be described in further detail by an example. The following example is an illustration of the present invention, and is not intended to limit the present invention.

### EXAMPLE

A smooth-surfaced chemical strengthened glass substrate (for example, N-5 glass substrate produced by HOYA) was used as a nonmagnetic substrate 1, and cleaned. Then, the glass substrate was introduced into a sputtering device, where 200 nm of a CoZrNb amorphous soft magnetic underlayer, 15 nm of a TiCr underlayer, and 30 nm of a TbCo magnetic layer were sequentially formed, and 5 nm of a protective layer comprising carbon was finally formed. The resulting magnetic recording medium was taken out from a vacuum device within the sputtering device. The sputtering steps for forming the respective layers were all performed in the customary manner by DC magnetron sputtering at a gas pressure of 5 mTorr.

For the formation of the magnetic recording layer (TbCo layer), the total flow rate of gases (Ar+H₂) was rendered constant, and the proportion of the H₂ gas to the total flow rate was varied. By this means, the flow rate of the H₂ gas was adjusted to a desired value. Then, a liquid lubricant layer comprising perfluoropolyether was formed to a thickness of 2 nm on the surface of the ma netic recording medium by dip coating to give a perpendicular magnetic recording medium.

In the above-described manner, the flow rate of the H₂ gas was variously changed to produce perpendicular magnetic recording media. Using each of the magnetic recording media, measurements were made of the Tb and Co concentrations of the magnetic recording layer, and the coercive force (Hc) and perpendicular magnetic anisotropy constant (Ku) of the magnetic recording medium.

The Tb and Co concentrations of the magnetic recording layer were measured by Inductively Coupled Plasma Atomic Emission Spectroscopy (ICP-AES). The magnetic property (coercive force (Hc)) was calculated from a magnetization curve obtained using a vibrating sample magnetometer. The perpendicular magnetic anisotropy constant (Ku) was calculated from a magnetic torque curve measured in a plane including the direction of the normal to the substrate surface.

Tb and Co concentrations of the Magnetic Recording Layer

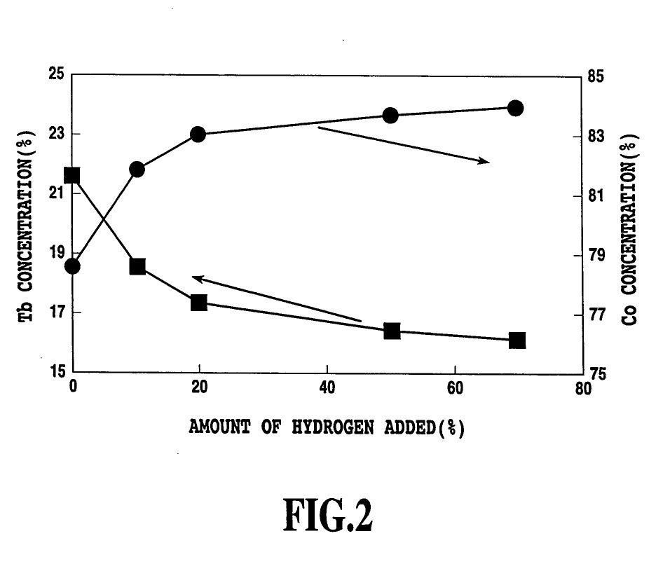

To investigate changes in the concentrations of Tb and Co in the magnetic recording layer according to the amount (%) of the H₂ gas added, composition analysis of the magnetic recording layer of the perpendicular magnetic recording medium was made for Tb and Co. FIG. 2 shows changes in the concentrations of Tb and Co versus the amount of an H₂ gas added during film formation of TbCo by sputtering. In FIG. 2, the amount (%) of the H₂ gas added represents the proportion of the amount of the H₂ gas added to the total flow rate of the film-forming gas. As shown in FIG. 2, when no H₂ gas was added, the proportions of Tb atoms and Co atoms contained in the magnetic recording layer were about 22:78. As the amount of H₂ gas increased, the proportion of Tb atoms to Co atoms decreased. Further, when 60% of H₂ gas was added, the ratio of Tb to Co was about 16:84. These changes in the composition show that when H₂ gas is added to the film-forming gas during formation of a rare earth-transition metal alloy amorphous magnetic recording layer by sputtering, the proportions of the rare earth element (Tb) and the transition metal (Co) vary greatly according to the amount of H₂ gas added.

Coercive Force (Hc)

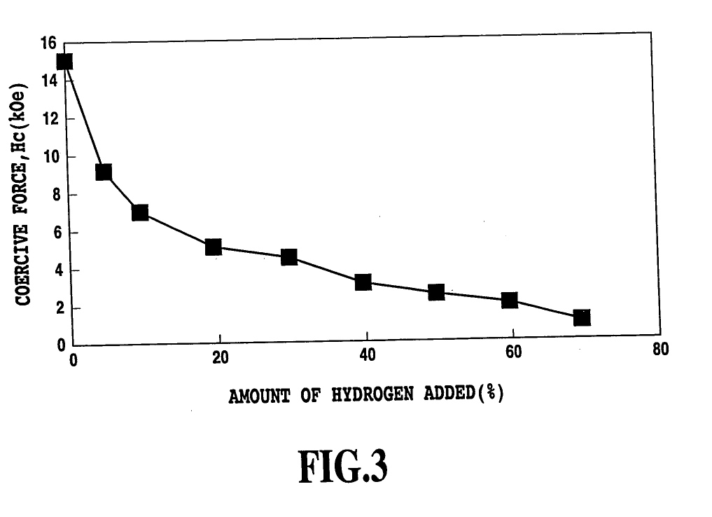

Changes in the coercive force (Hc) of the perpendicular magnetic recording medium according to the amount (%) of H₂ gas added were examined. FIG. 3 shows the changes in the coercive force (Hc) versus the amount of H₂ gas added. As shown in FIG. 3, when a small amount (about 2%) of H₂ gas was added, the coercive force sharply declined from 15 kOe to about 9 kOe. FIG. 3 further shows that as the amount of H₂ gas added was increased, the coercive force decreased, but the manner of the decrease was not very sharp. When the amount of H₂ gas added was 60%, the coercive force was about 2,000 Oe. With the amount of H₂ gas added being 70%, the coercive force was 1,000 Oe or less. With the perpendicular magnetic recording medium incorporating 70% of H₂ gas, a longitudinal component of the coercive force was also observed. When the amount of H₂ gas added was further increased, the coercive force measured in the perpendicular direction was nearly zero. Hence, when a rare earth-transition metal alloy amorphous magnetic recording layer is to be produced by sputtering with the addition of H₂ gas to the film-forming gas, the amount of H₂ gas added is preferably 60% or less. The lower limit of the amount of H₂ gas added is preferably 2% or more because of the demand for the coercive force of the perpendicular magnetic recording medium. Within such a range, the amount of H₂ gas added is adjusted, whereby the coercive force can be adjusted freely.

Perpendicular Magnetic Anisotropy Constant (Ku)

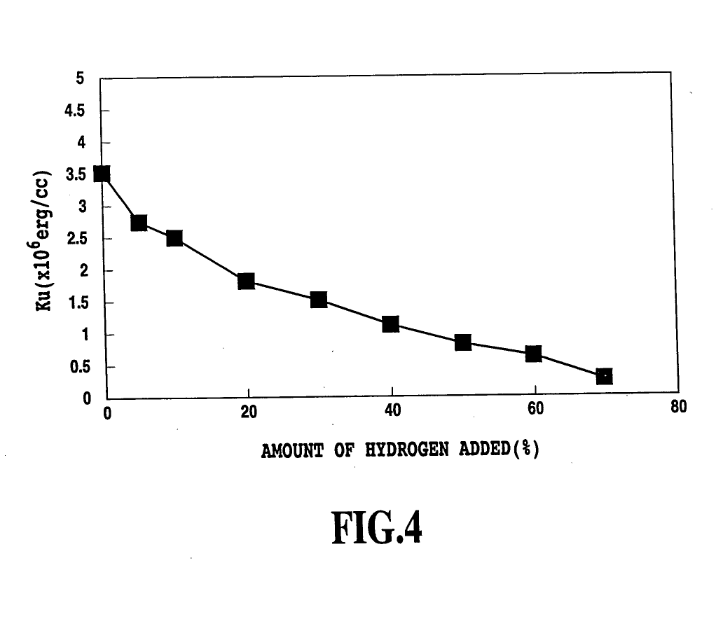

Changes in the perpendicular magnetic anisotropy constant (Ku) according to the amount (%) of H₂ gas added were examined. FIG. 4 shows the changes in the perpendicular magnetic anisotropy constant (Ku) with the amount of H₂ gas added. The perpendicular magnetic anisotropy constant (Ku) was obtained from a magnetic torque curve. As shown in FIG. 4, when no H₂ gas was added, the perpendicular magnetic anisotropy constant (Ku) was about 3.5×10⁶ erg/cc which is very high value. When H₂ gas was added to the film-forming gas, on the other hand, the value of the perpendicular magnetic anisotropy constant (Ku) decreased. As shown in FIG. 4, as the amount of H₂ gas added was increased, the value of the perpendicular magnetic anisotropy constant (Ku) decreased gradually. When about 60% of H₂ gas was added to the film-forming gas, the perpendicular magnetic anisotropy constant (Ku) came to 0.6×10⁶ erg/cc. When H₂ gas is added further, the magnetic recording layer becomes a longitudinally magnetized film having an easy axis of magnetization in the longitudinal direction. As will be seen from the measurements of the perpendicular magnetic anisotropy constant (Ku) of the perpendicular magnetic recording medium, when a rare earth-transition metal alloy amorphous magnetic recording layer is to be produced by sputtering with the addition of H₂ gas to the film-forming gas, the amount of H₂ gas added is preferably 60% or less.

Generally, a composition close to the compensation point is used with the rare earth-transition metal amorphous alloy system. A slight variation from this composition is known to cause great changes in magnetic properties. The above-mentioned changes in the magnetic properties (as shown in FIGS. 3 and 4) in the present invention may be attributed to changes in the composition of the rare earth-transition metal alloy amorphous magnetic recording layer as shown in FIG. 2 which have been induced by H₂ gas to the film-forming gas during formation of the rare earth-transition metal alloy amorphous magnetic recording layer.

As the present Example demonstrates, when a rare earth-transition metal alloy amorphous magnetic recording layer is to be formed by sputtering, an H₂ gas is added to the film-forming gas, and the proportion of the gas added is adjusted, whereby the proportions of the rare earth element and the transition metal in the magnetic recording layer can be adjusted, with the composition of the target of sputtering being kept constant. By so doing, the magnetic properties of the perpendicular magnetic recording medium can be adjusted to an arbitrary value.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

1-2. (canceled).

3. A method for producing a perpendicular magnetic recording medium, comprising the steps of sequentially laminating at least a soft magnetic underlayer, an underlayer, a magnetic recording layer, a protective layer, and a liquid lubricant layer on a nonmagnetic substrate,
wherein the magnetic recording layer is a rare earth-transition metal alloy amorphous film formed by sputtering, and
formation of the magnetic recording layer by sputtering is performed using a film-forming gas incorporating 2% or more, but 60% or less of an H₂ gas.

4. A method for producing a perpendicular magnetic recording medium, comprising the steps of:
(1) forming a soft magnetic underlayer on a nonmagnetic substrate,
(2) forming an underlayer on the soft magnetic underlayer,
(3) forming a magnetic recording layer on the underlayer,
(4) forming a protective layer on the magnetic recording layer, and
(5) forming a liquid lubricant layer on the protective layer,
wherein the magnetic recording layer is a rare earth-transition metal alloy amorphous film,
the rare earth-transition metal alloy amorphous film is formed by sputtering, and
formation of the rare earth-transition metal alloy amorphous film by sputtering is performed using a film-forming gas incorporating 2% or more, but 60% or less of an H₂ gas.

5. The method for producing a perpendicular magnetic recording medium according to claim 3, further comprising
a step of forming a layer for exercising magnetic domain control.

6. The method for producing a perpendicular magnetic recording medium according to claim 4, further comprising between the step (1) and the step (2) a step of forming a layer for exercising magnetic domain control.

7. The method for producing a perpendicular magnetic recording medium according to claim 3, wherein the soft magnetic underlayer, the underlayer, and the protective layer are formed by sputtering.

8. The method for producing a perpendicular magnetic recording medium according to claim 4, wherein the soft magnetic underlayer of the step (1), the underlayer of the step (2), and the protective layer of the step (4) are formed by sputtering.

9-12. (canceled).
